(19) United States
(12) Patent Application Publication
(10) Pub. No.: US 2007/0222414 A1
(43) Pub. Date: Sep. 27, 2007

(54) Battery jumper

(75) Inventor: Solomon Chen, Irwindale, CA (US)

Correspondence Address: Raymond Y. Chan, 108 N. Ynez Ave., #128, Monterey Park, CA, 91754, US

(73) Assignee: Superior Communications

(21) Appl. No.: 11/388,487

(22) Filed: Mar. 24, 2006

(51) Int. Cl. H02J 7/00

(52) U.S. Cl. 320/105

(57) ABSTRACT

A battery jumper for a battery having a battery terminal at a terminal side edge thereof includes a battery station, a recharging circuit, and a resilient unit. The battery station has a battery shoe adapted for coupling the terminal side edge of the battery to retain the battery in position. The recharging circuit includes a power inlet adapted for electrically connecting with a power source, and a charging terminal supported at the battery shoe for contacting with the battery terminal of the battery to recharge the battery. The resilient unit is supported at the battery shoe for applying a pushing force against the terminal side edge of the battery to minimize a pressure of the charging terminal against the battery terminal of the battery.

### BACKGROUND OF THE PRESENT INVENTION

1. Field of Invention

The present invention relates to a rechargeable battery, and more particularly to a battery jumper having an extreme compact size for conveniently charging a rechargeable battery in a wide variety of circumstances.

2. Description of Related Arts

A conventional battery charger usually comprises a charger station and a power adapter for charging a rechargeable battery, such as a rechargeable battery for a cellular phone or a digital camera. The charger station usually comprises a charger base having a disposing cavity formed thereon and a plurality of charging terminals provided on the disposing cavity for aligning with an electric terminal of the rechargeable battery, a recharging circuitry provided in the charger base and electrically connecting the charging terminals with the power adapter which is further connected with an external power source for charging the rechargeable battery.

A main disadvantage of this conventional battery charger is that it is bulky in size and therefore is not generally portable. This represents the major shortcoming of cellular phone utilization in that most cellular phones nowadays are sophisticatedly designed to have compact size and suitable for mobile use. Moreover, most rechargeable batteries have been developed to support extended usage of the cellular phones so that the present scenario is that both the rechargeable batteries and the cellular phones are optimally designed to support prolonged use while battery chargers have not been so designed and developed. As a consequence, cellular phones have not been utilized to their fullest extent.

Another disadvantage of conventional battery chargers is that the electric terminals of the battery chargers are usually pressed towards the electric terminals of the rechargeable batteries so as to ensure secure engagement between the electric terminals for allowing that the recharging process can be successfully accomplished. The problem here is that when the electric terminals are pressed too hard, each of the electric terminals will cause mutual damage to each other (i.e. the electric terminals of the battery chargers may cause mutual damage to the electric terminals of the rechargeable batteries) so that the general life-span of both the battery chargers and the rechargeable batteries will be substantially reduced. Very often, the cost of buying a new rechargeable battery is substantial when compared to the overall price of buying a new cellular phone. Moreover, when a particular model of cellular phone is outdated, the manufacturer may no longer manufacture the corresponding rechargeable battery so that the user may not be able to purchase a new rechargeable battery.

### SUMMARY OF THE PRESENT INVENTION

A main object of the present invention is to provide a battery jumper for a battery, wherein the battery jumper has an extreme compact size for conveniently charging a rechargeable battery in a wide variety of circumstances.

Another object of the present invention is to provide a battery jumper for a battery, wherein the battery jumper comprises a resilient unit for preventing electric terminals of the battery and the battery jumper to be pressed too hard against each other so as to prevent mutual damage of the battery and the battery jumper. In other words, the present invention improves the general life-span of the battery.

Another object of the present invention is to provide a battery jumper for a battery, which is capable of forming a compact personal accessory, such as a key chain, for facilitating easy carrying and storage of the battery jumper. In other words, the present invention allows widespread application thereof.

Another object of the present invention is to provide a battery jumper for a battery, which does not involve complicated and expensive mechanical or electrical components so as to minimize the manufacturing cost of the present invention.

Another object of the present invention is to provide a battery jumper for a battery, which allows packaging of cellular phone to become more compact due to the compact size of the battery jumper, so as to minimize the packaging cost of marketing a cellular.

Another object of the present invention is to provide a battery jumper for a battery, which is adapted not only to recharge the battery in an efficient manner, but also to provide a battery carrier for protecting the battery terminals while the battery is being carried in the battery jumper. In other words, when the present invention is not used as a charger, it acts as the battery carrier for safe and convenient carrying of the battery.

Accordingly, in order to accomplish the above objects, the prevent invention provides a battery jumper for a battery having a battery terminal at a terminal side edge thereof, comprising:

a battery station having a battery shoe adapted for coupling the terminal side edge of the battery to retain the battery in position;

a recharging circuit comprising a power inlet adapted for electrically connecting with a power source, and a charging terminal supported at the battery shoe for contacting with the battery terminal of the battery to recharge the battery; and

a resilient unit supported at the battery shoe for applying a pushing force against the terminal side edge of the battery to minimize a pressure of the charging terminal against the battery terminal of the battery.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a battery jumper according to a preferred embodiment of the present invention.

FIG. 2 is an exploded perspective view of the battery jumper according to the above preferred embodiment of the present invention.

FIG. 3 is a sectional side view of the battery jumper according to the above preferred embodiment of the present invention.

FIG. 4 is a first alternative mode of the battery jumper according to the above preferred embodiment of the present invention.

FIG. 5 is a second alternative mode of the battery jumper according to the above preferred embodiment of the present invention.

FIG. 6 is a third alternative mode of the battery jumper according to the above preferred embodiment of the present invention.

### DETAILED DESCRIPTION OF THE PREFERRED EMBODIMENT

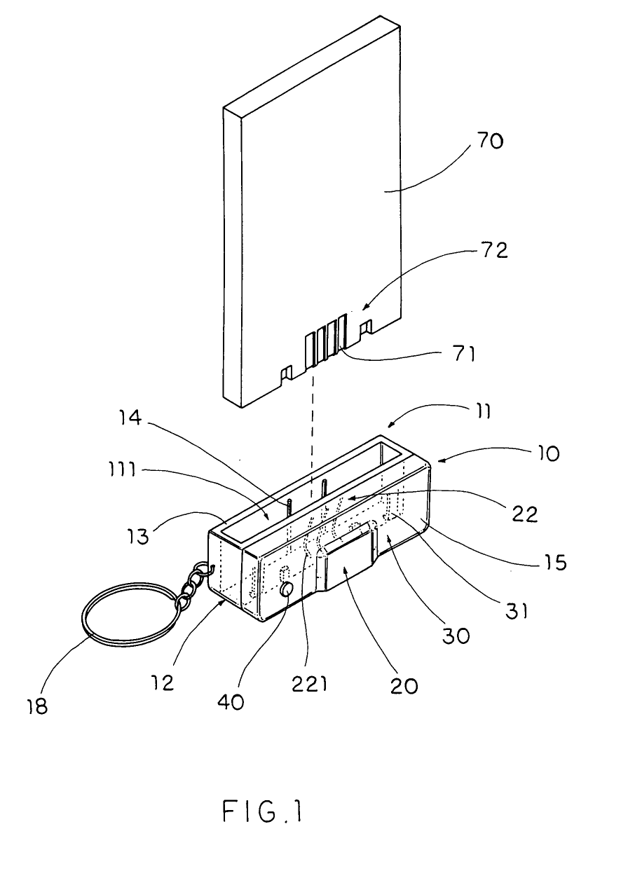

Referring to FIG. 1 to FIG. 3 of the drawings, a battery jumper for a battery 70 having a battery terminal 71 provided at a terminal side edge 72 thereof according to a preferred embodiment of the present invention is illustrated, in which the battery jumper comprises a battery station 10, a recharging circuit 20, and a resilient unit 30.

The battery station 10 has a battery shoe 11 adapted for coupling the terminal side edge 72 of the battery 70 to retain the battery 70 in position.

The recharging circuit 20 comprises a power inlet 21 adapted for electrically connecting with a power source, and a charging terminal 22 supported at the battery shoe 11 for contacting with the battery terminal 71 of the battery 70 to recharge the battery 70.

The resilient unit 30 is supported at the battery shoe 11 for applying a pushing force against the terminal side edge 72 of the battery 70 to minimize a pressure of the charging terminal 22 against the battery terminal 71 of the battery 70.

According to the preferred embodiment of the present invention, the battery jumper is for recharging the battery 70 having a predetermined height, thickness and length, wherein the height of the battery 70 is designed and crafted to be substantially greater than the width and the length of the battery 70 so as to allow it to securely stand on the battery jumper for recharging. The battery 70 is embodied as a conventional Li-ion battery suitable for use for a wide variety of cellular phones.

Moreover, the battery shoe 11 has a holding channel 111 having a depth corresponding to a height of the terminal side edge 72 of the battery 70 and a width slightly larger than a thickness of the battery 70, such that the holding channel 111 is adapted for the terminal side edge of the battery 70 slidably disposed therein to substantially hold the battery 70 on the battery station 10. In other words, the terminal side edge of the battery 70 is adapted to fittedly receive into the holding channel 111 for ensuring effective charging of the battery 70.

The battery station 10 further has a base portion 12 and a peripheral wall 13 upwardly extended therefrom to define the holding channel 111 within the peripheral wall 13 and the base portion 12 to form a compact structure of the battery station 10 so as to minimize a size of the battery jumper. It is worth mentioning that the height of the holding channel 111 is specifically designed such that the battery 70 is capable of securely engaging with the battery jumper and that the charging terminal 22 is securely and completely received and protected in the holding channel 111. In other words, the overall size of the present invention is deliberately minimized for convenient use and storage while ensuring proper and optimal functioning of the battery jumper.

The charging terminal 22 comprises a plurality of resilient terminal arms 221 spacedly extended at the battery shoe 11 for applying a pressing force against the battery terminal 71 of the battery 70 to contact therewith. It is worth mentioning that the resilient terminal arms 221 have a predetermined elasticity for normally extending in the holding channel 111 from an inner sidewall thereof such that when the terminal side edge 72 of the battery 70 is inserted into the holding channel 111, the resilient terminal arms 221 are pressed towards the inner sidewall while fittedly biasing against the battery terminal 71 of the battery 70. As a consequence, secure electric engagement between the battery 70 and the battery jumper is ensured.

On the other hand, the resilient unit 30 is provided at the battery shoe 10 adjacent to the terminal arms 221 for applying the pushing force on the battery 70 at the same direction of the pressing force of the charging terminal 22 to minimize the pressure of the terminal arms 221 when the terminal arms 221 press on the battery terminal 71 of the battery 70. In other words, the resilient unit 30 is adapted to prevent excessive pressing force being exerted on the battery terminal 71 of the battery 70 so as to prevent collateral damage of the battery terminal 71 and the charging terminal 22 which may be caused by pressing too hard to the battery terminal 71 by the charging terminal 22. As a result, the general life-span of the present invention as well as the battery 70 is ensured by minimizing the chance of terminal damage.

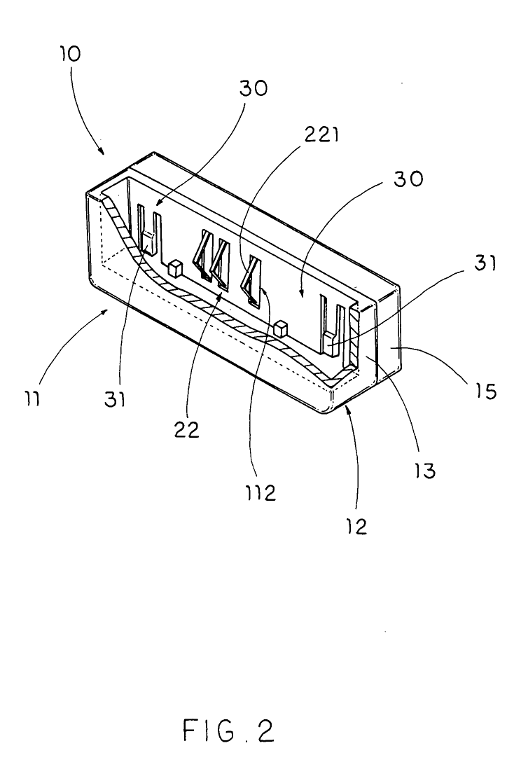

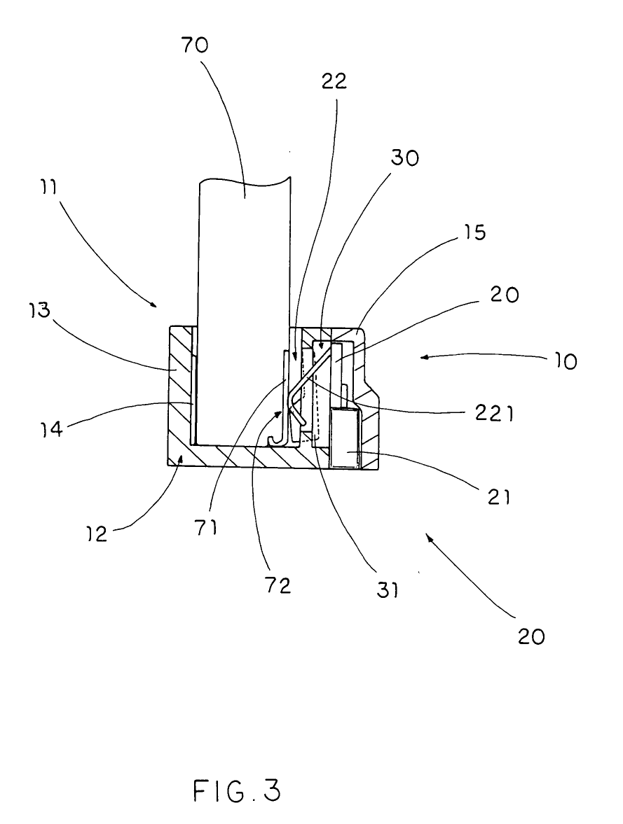

More specifically, as shown in FIG. 2 to FIG. 3 of the drawings, the resilient unit 30 comprises two resilient arms 31 spacedly and integrally formed on a longitudinal wall of the battery channel 111 at a position that the charging terminal 22 is provided on the longitudinal wall of the battery channel 111 between the two resilient arms 31 such that the two resilient arms 31 evenly apply the pushing force on the battery 70 to minimize the pressure at the charging terminal 22.

In order to achieve optimal engagement between the battery 70 and the battery jumper, the battery station 10 further comprises a plurality of engaging ribs 14 spacedly extended on the outer sidewall of the battery channel 111 so that when the terminal side edge 72 of the battery 70 is inserted into the battery channel 111, the engaging ribs 14 are arranged to bias against the corresponding outer surface of the battery 70 so as to achieve an optimal frictional engagement between the battery 70 and the battery station 10.

The battery station 10 further comprises a sealing compartment 15 extended from the battery shoe 11 to receive the recharging circuit 20 in the sealing compartment 15 at a position that the power inlet 21 is provided at a bottom side of the battery station 10 and the charging terminal 22 is extended from the sealing compartment 15 to the holding channel 111 of the battery shoe 11. Accordingly, the battery shoe 11 further has a plurality of terminal slots 112 spacedly formed on the sidewall of the holding channel 111 at positions corresponding with the positions of the resilient terminal arms 221 of the charging terminal 22 respectively, wherein each of the resilient terminal arms 221 is arranged to extend from the sealing compartment 15 to the holding channel 111 via the corresponding terminal slots 112.

According to the preferred embodiment of the present invention, the battery jumper further comprises a charging indicator 40 which is electrically connecting to the recharging circuit 20 and is provided on an outer wall of the battery station 10 for indicating a charging status of the battery 70. The charging indicator 40 preferably comprises an illuminating unit, such as a LED, for providing indication as to the charging status of the battery 70.

The power inlet 21 is preferably embodied as a USB inlet such that the battery jumper may acquire external power from conventional laptops. However, the power inlet 21 may also be embodied as a conventional power inlet adapted for connecting with an AC power source or an external adapter so as to acquire external power for charging the battery 70.

It is worth mentioning that the battery jumper may further comprise a metallic loop 18 provided on the battery station 10 for forming a key chain of the battery jumper so that it may be utilized as key chain or is adapted for mounting on another key chain, as shown in FIG. 1. As a result, widespread application of the present invention is facilitated.

Finally, one may appreciate that the battery jumper of the present invention can function as a battery protector instead of a battery charger. In such an embodiment, the battery station 10 does not have the recharging circuit 20 for recharging the battery 70. Instead, the battery shoe 11 forms as a battery carrier, wherein the battery terminal 71 of the battery 70 is securely received into the holding channel 111 so that the battery terminal 71 is substantially protected from damages caused by environmental interference. In other words, the battery station 10 is embodied for allowing the user to safely carry the battery 70 without the battery 70 being damaged by external factors. Thus, the battery jumper can be a safe carrying solution for the battery 70. Since the battery jumper securely holds the battery 70 and protects the battery terminals 71, it can be used as a safe means of carrying the battery 70 in purses, carrying bags or other accessories to prevent accidental shorting of the battery terminals 71. It is thus worth mentioning that the holding channel 111 is sized and shaped to fittedly receive the terminal side edge of the battery 70 so as to prevent the battery 70 from accidental disengaging from the holding channel 111.

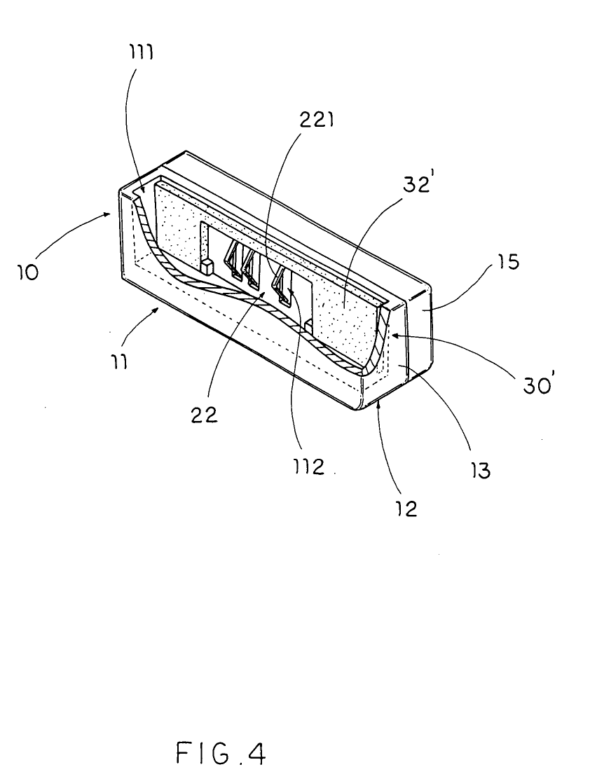

Referring to FIG. 4 of the drawings, a first alternative mode of the battery jumper according to the preferred embodiment of the present invention is illustrated. The first alternative mode is similar to the preferred embodiment except resilient unit 30′. According to the first alternative mode, the resilient unit 30′ comprises a resilient layer 32′, having a predetermined thickness, provided on a longitudinal wall of the battery channel 111 at a position that the charging terminal 22 is provided on the longitudinal wall of the battery channel 111, such that the resilient layer 32′ evenly applies the pushing force on the battery 70 to minimize the pressure at the charging terminal 22. Thus, the resilient layer 32′ is adapted to provide an optimal pushing force to the battery 70 for preventing collateral damage of the charging terminal 22 and the battery terminal 71.

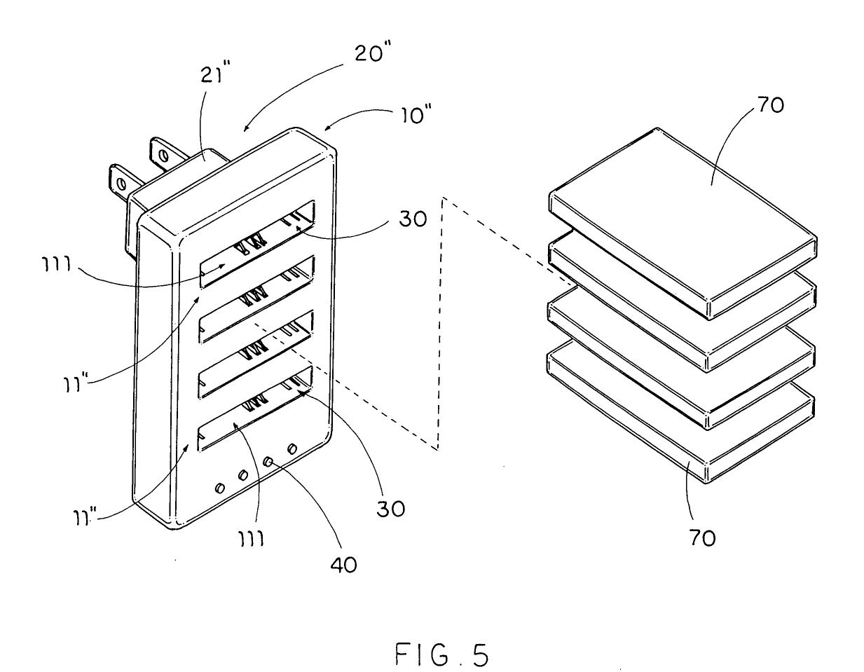

Referring to FIG. 5 of the drawings, a second alternative mode of the battery jumper according to the preferred embodiment of the present invention is illustrated. The second alternative mode is similar to the preferred embodiment except the battery station 10″. According to the second alternative mode, the battery station 10″ comprises a plurality of battery shoes 11″ formed thereon for allowing charging of a corresponding number of batteries 70. The power inlet 21″ of the rechargeable circuit 20″ is adapted to connect with an external AC power source for acquiring electricity. As a result, a user is able to charge a plurality of batteries 70 at the same time.

Moreover, the resilient unit 30 comprises a plurality of resilient arms 31 provided on the battery shoes 11″ respectively for ensuring that each of the batteries 70 is not damaged by the collateral force between the battery terminal 71 and the charging terminal 22.

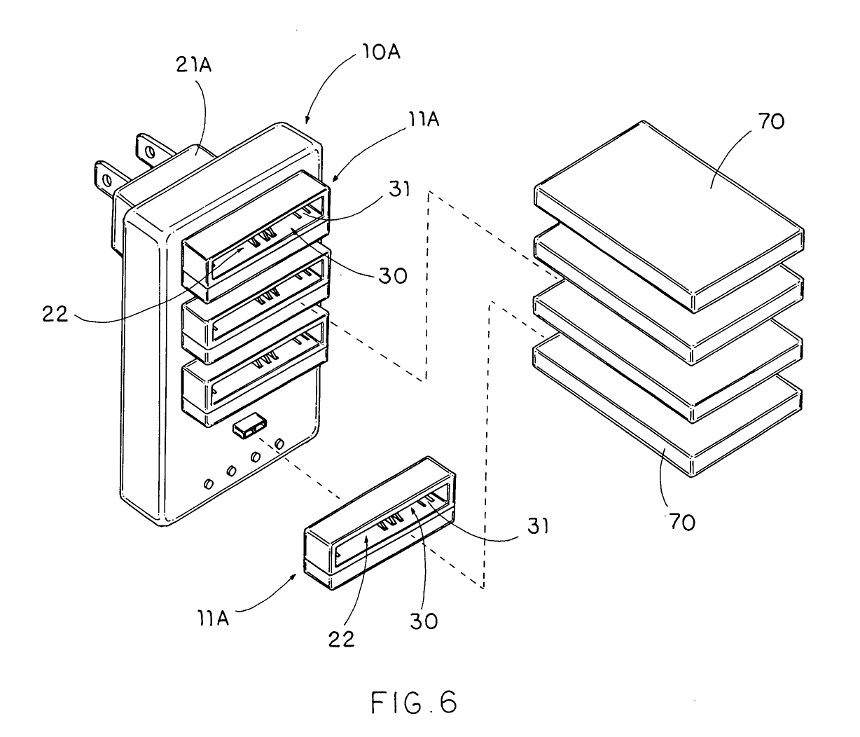

Referring to FIG. 6 of the drawings, a third alternative mode of the battery jumper according to the preferred embodiment of the present invention is illustrated. The third alternative mode is similar to the preferred embodiment except the battery station 10A. According to the third alternative mode, the battery station 10A comprises a plurality of battery shoes 11A detachably attached thereon for charging with a corresponding number of batteries 70. Accordingly, the resilient unit 30 comprises a plurality of resilient arms 31 provided on the battery shoes 11A respectively for ensuring that each of the batteries 70 is not damaged by the collateral force between the battery terminal 71 and the charging terminal 22. The power inlet 21A is adapted to connect to AC power source.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A battery jumper for a battery having a battery terminal at a terminal side edge thereof, comprising:
a battery station having a battery shoe adapted for coupling said terminal side edge of said battery to retain said battery in position;
a recharging circuit comprising a power inlet adapted for electrically connecting with a power source, and a charging terminal supported at said battery shoe for contacting with said battery terminal of said battery to recharge said battery; and
a resilient unit supported at said battery shoe for applying a pushing force against said terminal side edge of said battery to minimize a pressure of said charging terminal against said battery terminal of said battery.

2. The battery jumper, as recited in claim 1, wherein said battery shoe has a holding channel having a depth corresponding to a height of said terminal side edge of said battery and a width slightly larger than a thickness of said battery, such that said holding channel is adapted for said terminal side edge of said battery slidably disposed therein to substantially hold said battery on said battery station.

3. The battery jumper, as recited in claim 2, wherein said battery station has a base portion and a peripheral wall upwardly extended therefrom to define said holding channel within said peripheral wall and said base portion to form a compact structure of said battery station so as to minimize a size of said battery jumper.

4. The battery jumper, as recited in claim 1, wherein said charging terminal comprises a plurality of resilient terminal arms spacedly extended to said battery shoe for applying a pressing force against said battery terminal of said battery to contact therewith.

5. The battery jumper, as recited in claim 2, wherein said charging terminal comprises a plurality of resilient terminal arms spacedly extended to said battery shoe for applying a pressing force against said battery terminal of said battery to contact therewith.

6. The battery jumper, as recited in claim 3, wherein said charging terminal comprises a plurality of resilient terminal arms spacedly extended to said battery shoe for applying a pressing force against said battery terminal of said battery to contact therewith.

7. The battery jumper, as recited in claim 4, wherein said resilient unit is provided at said battery shoe adjacent to said terminal arms for applying said pushing force on said battery at the same direction of said pressing force of said charging terminal to minimize said pressure of said terminal arms when said terminal arms press on said battery terminal of said battery.

8. The battery jumper, as recited in claim 5, wherein said resilient unit is provided at said battery shoe adjacent to said terminal arms for applying said pushing force on said battery at the same direction of said pressing force of said charging terminal to minimize said pressure of said terminal arms when said terminal arms press on said battery terminal of said battery.

9. The battery jumper, as recited in claim 6, wherein said resilient unit is provided at said battery shoe adjacent to said terminal arms for applying said pushing force on said battery at the same direction of said pressing force of said charging terminal to minimize said pressure of said terminal arms when said terminal arms press on said battery terminal of said battery.

10. The battery jumper, as recited in claim 6, wherein said resilient unit comprises two resilient arms spacedly and integrally formed on a longitudinal wall of said battery channel at a position that said charging terminal is provided on said longitudinal wall of said battery channel between said two resilient arms such that said two resilient arms evenly apply said pushing force on said battery to minimize said pressure at said charging terminal.

11. The battery jumper, as recited in claim 9, wherein said resilient unit comprises two resilient arms spacedly and integrally formed on a longitudinal wall of said battery channel at a position that said charging terminal is provided on said longitudinal wall of said battery channel between said two resilient arms such that said two resilient arms evenly apply said pushing force on said battery to minimize said pressure at said charging terminal.

12. The battery jumper, as recited in claim 6, wherein said resilient unit comprises a resilient layer, having a predetermined thickness, provided on a longitudinal wall of said battery channel at a position that said charging terminal is provided on said longitudinal wall of said battery channel, such that said resilient layer evenly applies said pushing force on said battery to minimize said pressure at said charging terminal.

13. The battery jumper, as recited in claim 9, wherein said resilient unit comprises a resilient layer, having a predetermined thickness, provided on a longitudinal wall of said battery channel at a position that said charging terminal is provided on said longitudinal wall of said battery channel, such that said resilient layer evenly applies said pushing force on said battery to minimize said pressure at said charging terminal.

14. The battery jumper, as recited in claim 2, wherein said battery station further comprises a sealing compartment extended from said battery shoe to receive said recharging circuit in said sealing compartment at a position that said power inlet is provided at a bottom side of said battery station and said charging terminal is extended from said sealing compartment to said holding channel of said battery shoe.

15. The battery jumper, as recited in claim 11, wherein said battery station further comprises a sealing compartment extended from said battery shoe to receive said recharging circuit in said sealing compartment at a position that said power inlet is provided at a bottom side of said battery station and said charging terminal is extended from said sealing compartment to said battery shoe.

16. The battery jumper, as recited in claim 13, wherein said battery station further comprises a sealing compartment extended from said battery shoe to receive said recharging circuit in said sealing compartment at a position that said power inlet is provided at a bottom side of said battery station and said charging terminal is extended from said sealing compartment to said battery shoe.

17. The battery jumper, as recited in claim 1, further comprising a charging indicator which is electrically connecting to said recharging circuit and is provided on an outer wall of said battery station for indicating a charging status of said battery.

18. The battery jumper, as recited in claim 9, further comprising a charging indicator which is electrically connecting to said recharging circuit and is provided on an outer wall of said battery station for indicating a charging status of said battery.

19. The battery jumper, as recited in claim 15, further comprising a charging indicator which is electrically connecting to said recharging circuit and is provided on an outer wall of said battery station for indicating a charging status of said battery.

20. The battery jumper, as recited in claim 16, further comprising a charging indicator which is electrically connecting to said recharging circuit and is provided on an outer wall of said battery station for indicating a charging status of said battery.

21. A battery jumper for a battery having a battery terminal at a terminal side edge thereof, comprising:
a battery station having a battery carrier adapted for coupling said terminal side edge of said battery to retain said battery in position, wherein said battery carrier has a holding channel having a depth corresponding to a height of said terminal side edge of said battery and a width corresponding to a thickness of said battery, such that said holding channel is adapted for said terminal side edge of said battery slidably disposed therein to substantially hold said battery on said battery station for convenient carrying of said battery, and to substantially protect said battery terminal of said battery from environmental damage.

22. The battery jumper, as recited in claim 21, wherein said battery station has a base portion and a peripheral wall upwardly extended therefrom to define said holding channel within said peripheral wall and said base portion to form a compact structure of said battery station so as to minimize a size of said battery jumper.

23. The battery jumper, as recited in claim 22, wherein said holding channel is shaped and sized to fittedly receive said terminal side edge of said battery for securely holding said battery in said holding channel for protecting said battery terminal and preventing said battery from accidental disengaging from said holding channel.
